(19) United States
(12) Patent Application Publication
(10) Pub. No.: US 2003/0029552 A1
(43) Pub. Date: Feb. 13, 2003

(54) Method and apparatus for adhesively bonding corner protectors onto picture frames and the like

(76) Inventor: Joseph S. Parcels, Anaheim, CA (US)

Correspondence Address: Law Offices of William L. Chapin, 16791 Sea Witch Lane, Hunington Beach, CA, 92649, US

(21) Appl. No.: 09/927,949

(22) Filed: Aug. 10, 2001

(51) Int. Cl. B65C 1/00; B32B 1/00

(52) U.S. Cl. 156/212; 156/475; 156/476; 156/477.1

(57) ABSTRACT

A method and apparatus for installing corner protectors onto picture frames, to protect the corners from damage during shipment, uses preforms made of a thin, flat sheet of cardboard having left and right flap sections, one of which, e.g., the right one, is bendable from the plane of the sheet to form an upper cover flap, the left flap section forming a lower cover flap. Left and right flap sections are joined at parallel vertical sides thereof to opposite vertical sides of a vertically elongated, rectangularly-shaped inner spine flap for covering a vertical side of a “right hand” picture frame molding. A horizontally elongated, rectangularly-shaped outer spine flap protrudes from a lateral edge of the lower cover flap, and a trapezoidally-shaped securement flap protrudes from the outer spine flap. A preform is positioned below a frame corner, with outside walls of left and right intersecting picture frame moldings aligned with the base and inner vertical side, respectively, of the lower cover flap, and above a pair of left and right folder mechanisms that include flap folder arms which fit into worktable recesses. A hot-melt adhesive applicator head sprays a first blob of adhesive onto an upper surface of the left-hand frame molding, whereupon a first flap folder arm is elevated to bend the outer spine flap and securement flap into a vertical position adjacent the outer vertical side of the left-hand frame molding; the first flap folder arm is then rotated towards the inside of the frame, bending the securement flap over the adhesive blob on the frame molding. A second adhesive blob is then sprayed onto the upper surface of the securement flap. Next, the second flap folder arm is elevated to bend the inner spine flap and upper cover flap into a vertical position adjacent the outer side of the right-hand frame molding, whereupon the second flap folder arm is rotated inwardly to bend the upper cover flap into a horizontal position over the second adhesive blob on the securement flap. The applicator head is then pressed against the upper cover flap, thus adhering the second adhesive blob to the upper cover flap and securement flap to form a corner protector, and adhering the first adhesive blob to the securement flap and left-hand frame molding to secure the corner protector to the frame.

### BACKGROUND OF THE INVENTION

A. Field of the Invention

The present invention relates to methods and apparatus for protecting the corners of rectangularly-shaped frames such as picture frames, from impact damage during shipping. More particularly, the invention relates to a method and apparatus for adhesively bonding corner protectors onto the corners of a picture frame.

B. Description of Background Art

Picture frames for holding and displaying paintings, photographs, diplomas, certificates and similar flat articles are manufactured in prodigious quantities worldwide. Although picture frames vary in shape and construction details, most frames have a rectangular plan view shape. Moreover, the structure of most picture frames consists essentially of four elongated, straight channel members or moldings, each having formed therein an inner longitudinally disposed channel that intersects channels of adjacent members at ninety degree angles. Four such channel members fastened together form a rectangular ring-shaped frame. The channels or recesses in the moldings face inwardly of the frame, and comprise spaces for receiving a rectangularly-shaped flat display piece such as a photograph or painting, and sometimes, a backing panel, mat and protective cover glass.

Picture frames of the type described above are made from a variety of materials including, wood, metal and plastic. Whatever material the frame is made of, the geometry of a rectangular picture frame dictates that it have four peripheral members or moldings of generally uniform thickness which are joined to each other at forty-five degree miter angles to form ninety-degree corners. Since the sides of each molding intersect at an acute angle, i.e., 45 degrees, the frame corners as well as the molding corners are sharp, and are therefore highly subject to breakage, denting or cosmetic damage during shipment. Accordingly, most picture frames, whether empty or occupied, are fitted with some sort of corner protectors during shipment. Such corner protectors are usually made of a relatively inexpensive recyclable material such as cardboard or polystyrene foam. Typical corner protectors of this type are disclosed in U.S. Pat. Nos. 3,955,677, 4,598,825, and 5,447,233. Other patents, related to protecting corners of objects during shipping include U.S. Pat. No. 4,407,898. Also, U.S. Pat. No. 5,255,458 discloses a three-dimensional picture corner and U.S. Pat. No. 4,787,553 discloses a corner fastening device.

In addition to the above-referenced patents related to corner protectors and the like, a variety of machines for bending sheet metal or cardboard of the type used for corner projectors have been disclosed in the following U.S. Pat. Nos: 4,132,102, 4,585,432, 4,713,957, 4,857,038, 4,956,961, and 5,184,998.

None of the aforementioned references disclose a machine for automatically attaching corner protectors to picture frames. Accordingly, the task of attaching corner protectors to picture frames was formerly labor intensive and time consuming. In response to those limitations of the prior art, the present inventor disclosed an automatic Method and Apparatus For Attaching Corner Protectors to Picture Frames, in U.S. Pat. No. 6,018,934. In that patent, the present inventor disclosed a method and apparatus for installing covers to protect picture frame corners from damage during shipment, utilizing thin cardboard preforms having symmetric, left and right-hand, right-triangular coverflaps joined at vertical sides thereof to opposite vertical sides of a vertically elongated, rectangular spine flap, the left-hand triangular cover flap having depending downwardly from its base a horizontally elongated rectangular side cover flap, and depending downwardly from the lower lateral edge of the side cover flap a trapezoidally-shaped securement flap. The preform is positioned below a picture frame corner, with intersecting side members of the frame vertically aligned with the sides of the left-hand right-triangular cover flap, which serves as a lower face cover flap. The apparatus includes folder mechanisms including flap folder arms which are retractable into recesses provided in a work table, and which are extendible and rotatable to thereby bend the side cover flap and securement flap into a vertical position adjacent a first side of the frame corner and perpendicularly inwardly to overlie the first frame member, bend the spine flap and right-hand triangular coverflap into a vertical position adjacent the second frame member, and bend the right-hand triangular flap perpendicularly inwards from the spine flap to overlie the second and first frame members. An automatic staple gun then inserts a staple downwardly through the right-triangular cover flap into the securement flap and left-hand frame member, securing the corner protector in a folded disposition over the frame corner. The present invention was conceived of to provide a method and apparatus for adhesively bonding corner protectors on the corners of picture frames, the method and apparatus being suitable for use with picture frames made of metal or plastic, as well as wood.

### OBJECTS OF THE INVENTION

An object of the present invention is to provide a method for attaching protective covers to the corners of a picture frame, using an adhesive bonding process.

Another object of the invention is to provide an apparatus for automatically attaching protective covers to the corners of picture frames using adhesive bonds.

Another object of the invention is to provide a method and apparatus for automatically attaching protective covers to the corners of picture frames, in which a cover is bonded to the corner of a frame by an adhesive bond, not requiring penetration of the frame by a fastener.

Another object of the invention is to provide a method and apparatus for automatically attaching protective covers to corners of a picture frame in which adhesive is applied to a surface of a frame molding, a protective cover is positioned over the cover, and the cover pressed against the adhesive to bond the cover to the frame molding.

Another object of the invention is to provide an apparatus for depositing a quantity of adhesive on a surface of a picture frame molding, folding a flat sheet of flexible material over the corner of a picture frame, depositing a quantity of adhesive on a surface of the sheet, securing the folds of the sheet together by pressing an upper portion of the folded sheet against a lower portion having adhesive on its surface to form a protective cover, and adhering the cover to the picture frame by pressing the cover against adhesive on the molding surface.

Another object of the invention is to provide an apparatus for bending a cardboard preform cut to a pre-determined shape over the corner of the picture frame, securing the folded portions of the cardboard preform by compressing a liquid adhesive therebetween and allowing the liquid adhesive to solidify, thereby forming a corner protector, and securing the corner protector to a molding of the frame by compressing a liquid adhesive between the molding and corner protector and allowing the liquid adhesive to solidify, thereby adhesively bonding the corner protector to the frame.

Another object of the invention is to provide a picture frame corner protector attaching apparatus which includes means for clamping and holding a corner of a picture frame, positioning under the picture frame corner a preform sheet of flexible material, the preform sheet having the shape of left and right, lower and upper right triangular-shaped cover flaps joined at their inner vertical edges by a vertically elongated, rectangular-shaped inner spine flap to form a shape approximating that of a truncated isosceles triangle, the preform having a horizontally elongated, rectangularly-shaped outer spine flap depending downwardly from the left triangular corner flap and shaped similarly to the inner spine flap, and having depending downwardly therefrom a trapizoidally-shaped securement flap, means for spraying a first quantity of adhesive onto the upper surface of a first frame molding overlying the lower triangular-shaped cover flap, bending the outer spine flap vertically upwards into contact with the outer lateral side of the first frame molding, bending the securement flap down into a horizontal position in contact with the adhesive on the surface of the first frame molding, bending the inner spine flap and upper triangular cover flap vertically upwards into contact with the outer lateral surface of the second frame molding, spraying a second quantity of adhesive onto the upper surface of the securement flap overlying the first quantity of adhesive and bending the upper triangular cover flap into compressive contact with the second quantity of adhesive, thereby securing the upper triangular cover flap to the securement flap to form a completed cover protector, and pressing the first quantity of adhesive between the lower surface of the securement flap and the upper surface of the first frame molding to thereby secure the corner protector to the frame.

Various other objects and advantages of the present invention, and its most novel features, will become apparent to those skilled in the art by perusing the accompanying specification, drawings and claims.

It is to be understood that although the invention disclosed herein is fully capable of achieving the objects and providing the advantages described, the characteristics of the invention described herein are merely illustrative of the preferred embodiments. Accordingly, I do not intend that the scope of my exclusive rights and privileges in the invention be limited to details of the embodiments described. I do intend that equivalents, adaptations and modifications of the invention reasonably inferable from the description contained herein be included within the scope of the invention as defined by the appended claims.

### SUMMARY OF THE INVENTION

Briefly stated the present invention comprehends a method and apparatus for automatically and adhesively bonding protective covers made of a sheet of flexible material, e.g., cardboard, stock to the corners of frames, particularly rectangularly-shaped frames of the type used to hold pictures, documents and the like, the covers being intended to protect the corners of the frame from damage during shipment.

A preferred embodiment of an automatic adhesive bonding method and apparatus according to the present invention preferably utilizes corner protectors made from thin, flat sheets of cardboard, each pre-cut, by die cutting, for example, into a generally triangular shape which includes panel sections which are bent out from the plane of the sheet to form cover flaps which are to be folded over and enclose a corner and adjacent portions of the side channel members of a conventional rectangularly-shaped picture frame. Four such corner protectors are used to cover the four corners of the frame.

In a preferred embodiment of the invention, the plan view shape of the upper, larger portion of the corner protector preform includes two mirror symmetric, left and right, right-triangularly-shaped, panel sections having collinear horizontal bases joined to opposite vertical sides of a vertically elongated rectangular, inner, or right-hand spine panel section. The left and right triangularly-shaped panel sections serve as lower and upper cover flaps, while the inner spine panel section serves as a first, right-hand spine cover flap for a picture frame corner, as will be described below. Thus shaped, the upper portion of the preform has the appearance of an isosceles triangle whose vertex is horizontally truncated. The preform preferably includes a lower portion that has a horizontally elongated, rectangularly shaped outer, or left-hand spine flap panel section which depends downwardly from the base of one of the right-triangle flap panels, the left one, for example, and has the same width as that panel. A trapezoidally-shaped securement flap panel section depends downwardly from the bottom edge of the outer spine flap panel, the securement flap panel having a lower edge wall parallel to but shorter than that of the outer spine flap panel. In a preferred embodiment, the horizontal width of the vertically elongated inner spine flap panel and the vertical height of the horizontally elongated outer spine flap panel have a common value which is slightly greater than the thickness of a picture frame which is to be protected, e.g., about 16/16 inch for a frame thickness of ⅝ inch. Preferably, the vertical side walls of the vertical inner spine flap panel and the horizontally disposed upper and lower edges of the outer spine flap panel are scored to facilitate folding those respective flaps to contact adjacent perpendicular channel members or moldings of a picture frame.

According to the method of the present invention, a preform, score lines up, is positioned below a corner of a picture frame. The corner of the frame is oriented with respect to a preform with a pair of perpendicularly intersecting adjacent molding side walls defining the corner of the frame vertically aligned with the perpendicular sides of the left-hand, lower right-triangular cover flap having the downwardly depending outer spine and securement flaps. A first quantity of adhesive is then deposited on the upper surface of left-hand frame molding, near its intersection with the right-hand frame molding. Preferably, the first quantity of adhesive consists of one or more blobs of molten hot melt adhesive sprayed onto the upper surface of the molding from one or more nozzles of a pressurized hot melt glue gun positioned above the frame. The outer spine flap and securement flap are then folded vertically upwards as a planar unit along the upper or inner score line defining the junction between the base of the left, lower, right triangularly-shaped lower cover flap and the outer spine flap. Next, the securement flap is folded downwardly and inwardly along the lower or outer score line towards a horizontal position, and the securement flap is pressed down onto the semi-liquid glue blobs on the upper surface of the frame member overlying the left, lower triangularly-shaped cover flap. A second quantity of adhesive is then deposited on the upper surface of the securement flap by the glue gun. Then, the second, right-hand, right-triangularly-shaped upper cover flap and inner spine flap are bent upwards as a unit along the innermost vertical fold line, i.e., the left-hand vertical edge of the inner spine flap, to a vertical position. The right-hand, upper triangular cover flap is then bent downwardly and laterally along the outermost, right-hand vertical fold line of the inner spine flap to a horizontal position overlying the securement flap and pressed down against the second quantity of adhesive on the upper surface of the securement flap, thus securing the overlying, upper right-hand triangular cover flap to the securement flap.

The apparatus according to the present invention includes a base plate or work table having a flat upper surface for supporting a corner of a picture frame, and a frame holder clamping jig for receiving and holding the corner of the picture frame on the surface of the table.

Mounted on the table is a corner protector installation mechanism which includes a pair of corner protector flap folder actuators positioned on opposite sides of the corner of a picture frame held in the clamping jig. Each corner folder actuator includes a flat, rectangularly-shaped flap-contacting arm mounted near a longitudinal end thereof on the upper end of a post which is actuable by a linear actuator from a lower inactive position in which the arm resides within a rectangularly-shaped recess in the upper surface of the base plate, with the upper surface of the arm flush with the upper surface of the base plate, to an upper, active position. Each post also includes a 90-degree rotary actuator means, which is effective in rotating a flap contacting arm, when raised, from an outer position contacting the outer vertically disposed side of a flap to an inner position effective in exerting an inwardly and downwardly directed folding force on the flap.

In operation, the first corner folder actuator arm is extended vertically, folding the outer spine flap and securement flap upwardly into a vertical position adjacent one side of a frame. An automatic hot melt adhesive gun applicator head having nozzles pressurized by air then deposits sprays a first quantity of hot melt adhesive onto the upper surface of the frame molding adjacent to the first folder actuator arm. The arm is then rotated inwards, bending the securement flap inwardly and downwardly into contact with the first quantity of semi-liquid adhesive on the upper surface of the first frame molding strip, thus bonding the securement flap to the frame.

Next, the actuator arm of the second corner folder actuator is elevated, folding the upper triangular corner protector flap upwardly to a position vertically adjacent the outer edge of the second frame molding strip. The arm of the first corner folder actuator is then rotated outwardly from its position overlying and holding down the securement flap. A second quantity of molten hot melt adhesive is then sprayed onto the upper surface of the securement flap. The arm of the second actuator is then rotated inwardly, bending the upper triangular cover flap down into contact with the securement flap. This action presses the upper triangular cover flap down against the second quantity of adhesive on the upper surface of the underlying securement flap, thereby securing adhering the flaps to each other. The applicator head is then moved forcibly downwards by a pneumatic actuator, causing a pair of fingers protruding downwardly from the head to press downwardly on the upper surface of the upper triangular cover flap, causing secure adhesive bonds to be formed between the securement flap and frame, and between the upper triangular cover flap and securement flap. Both actuator arms are then automatically rotated and retracted to their recessed positions, flush with the work table surface. At the same time, the frame holding clamp is also automatically released, allowing the frame with attached corner protector to be removed from the clamp.

The apparatus according to the present invention may optionally include means for automatically and substantially simultaneously initiating operation of a pair of corner protector installation mechanisms of the type described above, each time two adjacent corners of a picture frame are fully inserted into and correctly oriented with respect to clamping jigs of the mechanisms. In a preferred embodiment, apparatus components for implementing this automatic operation include a pair of guide plates in each clamping jig that have inner vertically disposed wall surfaces that define therebetween a ninety degree intersection angle or vertex, which is cut off or truncated by a plane oriented at forty-five degrees to the guide bars, to thereby form an opening for insertably receiving the corner of picture frame, with the intersecting channel moldings of the frame aligned with the guide plates.

Each guide plate is provided, near the opening between the inner longitudinal ends of the guide plate, with a sensor which provides an electrical signal indicating that a frame corner molding has been fully inserted into the clamping jig. The electrical signals from each pair of sensors for each of the two clamping jigs are logically ANDed, producing a command signal to initiate automatic operation of the machine only when all three outer sides of the frame channel moldings defining two adjacent corners of the frame are fully inserted into and properly aligned with the guide plates of the two clamping jigs for proper operation of the corner protector folding and attaching operation. This command signal initiates a sequence of operations by which a pair of corner protectors are automatically attached in tandem to the two corners of a picture frame. Upon completion of this automatic operation, the holding clamps of both clamping jigs are automatically released, allowing the frame with a pair of attached corner protectors installed to be withdrawn from engagement with the apparatus. The frame may then be rotated one hundred and eighty degrees in a horizontal plane, and re-inserted into the apparatus to initiate attachment of a pair of corner protectors to the remaining two corners of the picture frame.

### BRIEF DESCRIPTION OF THE DRAWINGS

FIG. 1 is a front perspective view of an apparatus for adhesively bonding corner protectors onto picture frames according to the present invention, showing a hot melt adhesive machine comprising part of the apparatus.

FIG. 2 is a fragmentary upper rear perspective view of the apparatus of FIG. 1 on an enlarged scale, and showing guide rods and preforms used therewith removed to show details of the apparatus.

FIG. 3 is a front perspective view of an adhesive applicator head comprising part of the apparatus of FIG. 1.

FIG. 4 is a front elevation view of the applicator head of FIG. 3.

FIG. 5 is a side elevation view of the applicator head of FIG. 3.

FIG. 6 is a lower plan view of the applicator head of FIG. 3.

FIG. 7 is an upper plan view of a corner protector preform or blank usable with the apparatus of FIG. 1.

FIG. 8 is a rear perspective view of the apparatus of FIG. 2 showing a supply of corner protector preforms or blanks of the type shown in FIG. 7 in a stack preparatory to feeding individual preforms into a clamping position on the apparatus.

FIG. 9 is a rear perspective view similar to that of FIG. 8, but showing an individual corner protector preform advanced to a clamping location, and showing a corner protector in a stack from which the individual corner protector was advanced.

FIG. 10 is a view similar to that of FIG. 9, but showing a corner of a picture frame inserted into a clamping jig comprising part of the apparatus, the picture frame corner being positioned above the individual corner protector preform of FIG. 9, and showing a clamp bar of the clamping jig brought down into compressive contact with the upper surface of the picture frame.

FIG. 11 is a view similar to that of FIG. 10, but showing streams of adhesive issuing from the adhesive applicator head of FIGS. 3 through 6, the streams impinging on the upper surface of a channel member of the picture frame to thereby deposit thereon a first adhesive blob consisting of two glue dots.

FIG. 12 is a view similar to that of FIGS. 10 and 11, but showing a first corner flap actuator comprising part of the apparatus in an upwardly actuated position.

FIG. 13 is a view of the apparatus of FIG. 1 similar to that of FIG. 12, but showing a fold-effecting arm of the first corner flap actuator rotated to contact and fold down a securement flap of the corner protector preform into a position overlaying the picture frame.

FIG. 14 is a view similar to that of FIG. 13, but showing streams of adhesive issuing from the adhesive applicator head of FIGS. 2 through 6, the streams impinging on the upper surface of the securement flap to thereby deposit thereon a second adhesive blob consisting of two glue dots.

FIG. 15 is a view of the apparatus similar to that of FIG. 13, but showing a second corner flap actuator of the apparatus in an upwardly actuated position.

FIG. 16 is a view of the apparatus of FIG. 1 similar to that of FIG. 15, but showing a fold-effecting arm of the second corner flap actuator rotated to contact and fold down a triangularly-shaped upper cover flap of the corner protector preform into a position overlying the securement flap of the corner protector preform.

FIG. 17 is a view of the apparatus of FIG. 1 similar to that of FIG. 16, but showing the fold-effecting arm of the first corner flap actuator rotated back into an inactive, home position, and showing an adhesive applicator head comprising part of the apparatus actuated downwardly to thereby press a flat lower portion of the head forward of nozzles protruding downwardly from the head into compressive contact with the upper surface of that portion of the second, triangularly-shaped upper cover flap overlying the securement flap of the corner protector preform, thereby pressing the glue dots between the flaps together to thereby adhere the flaps together and thereby pressing the lower surface of the securement flap against the glue dots on the picture frame channel molding, thereby adhering the securement flap to the picture frame.

FIG. 18 is a fragmentary side elevation view of the apparatus of FIG. 17, showing the applicator head on an enlarged scale, but in a partially lowered position.

FIG. 19 is a view similar to that of FIG. 18, but showing the applicator head in a fully lowered position, as shown in FIG. 17.

### DESCRIPTION OF THE PREFERRED EMBODIMENTS

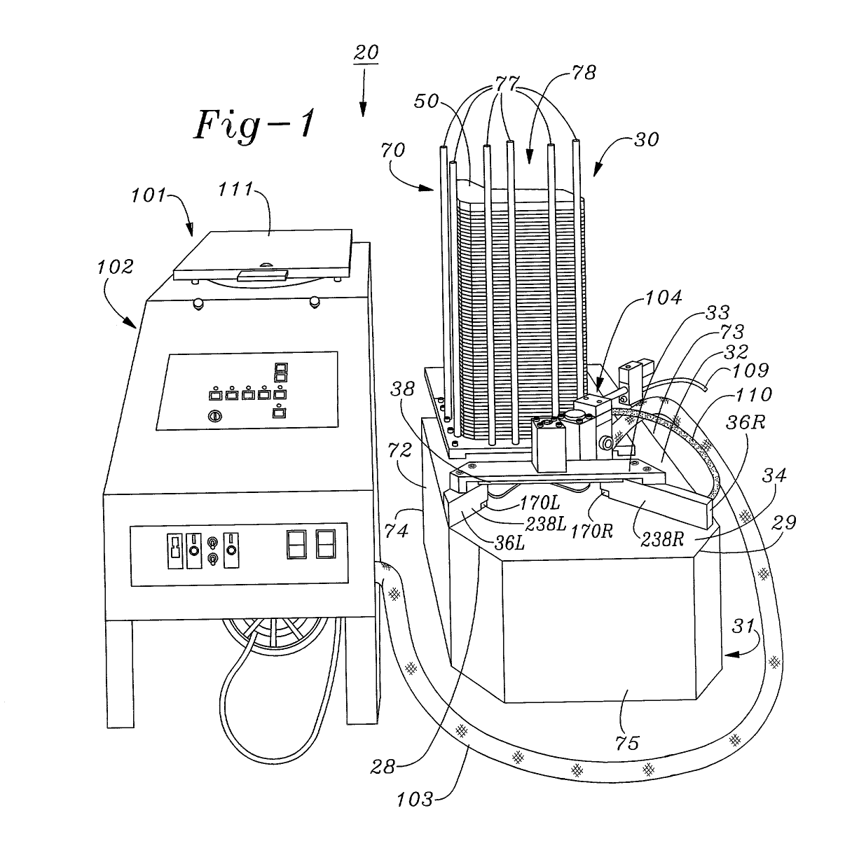

FIGS. 1-19 depict a method and apparatus according to the present invention for adhesively bonding corner protectors onto picture frames and the like. The structure and function of certain portions of the apparatus according to the present invention are described in detail in the present inventor's U.S. Pat. No. 6,018,934, the entire specification, claims, drawings, and abstract which are hereby incorporated by reference into the present application.

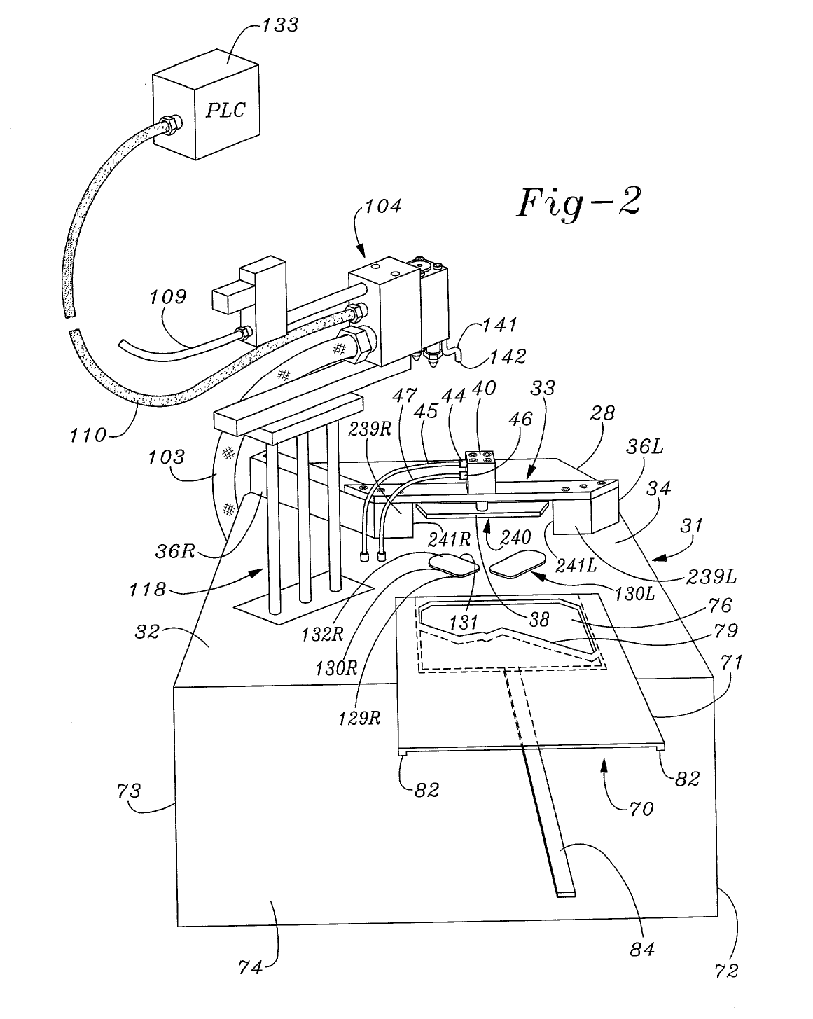

Referring now to FIGS. 1 and 2, an apparatus 20 for adhesively bonding corner protectors onto the corners of picture frames and the like may be seen to include a corner protector installation mechanism 30. Mechanism 30 is similar in structure and function to the apparatus disclosed in U.S. Pat. No. 6,018,934. Notably, however, as will be described in detail below, mechanism 30 according to the present invention utilizes an adhesive dispensing gun rather than the staple gun disclosed in the '934 patent. Thus, corner protector installation mechanism 30, in contrast to the apparatus disclosed in the '934 patent, can be used to install corner protectors on frames, such as metal or plastic frames, where it would not be feasible to staple the protector to the frame.

As shown in FIGS. 1 and 2, corner protector installation mechanism 30 includes a generally rectangular box-shaped enclosure 31 surmounted by a generally flat, upper base plate or work table 32. As may be seen best by referring to FIG. 1, apparatus 30 includes an elongated, generally straight frame holder/clamping jig 33 mounted on the upper surface 34 of work table 32. Preferably, clamping jig 33 is disposed obliquely, e.g., at 45 degrees, with respect to the rectangular plan-view shape of work table 32. As shown in FIGS. 1, 8, 10 and 18, clamping jig 33 is spaced above upper surface 34 of table 32, and includes a longitudinally elongated, horizontally disposed, generally rectangular-shaped upper straight beam member 35, supported at opposite transverse ends thereof by a pair of laterally opposed, left and right guide plates 36L, 36R, respectively. Guide plates 36 have flat and parallel lower and upper surfaces, 236 and 237, these surfaces supporting clamp beam member 35 so that its lower surface 37 is parallel to and spaced above upper surface 34 of work table 32.

As shown in FIG. 1, enclosure 31 of mechanism 30 has parallel, vertically disposed left and right side panels 72 and 73, which are perpendicular to front and rear vertically disposed panels 75, 74. Front panel 75 is preferably joined to left and right side panels 72, 73 by left and right vertically disposed transition panels 28, 29. The latter are obliquely angled to front panel 75, e.g., at 45 degrees. This construction enables pairs of mechanisms 30 to be oriented with longitudinal axes of the mechanism, defined by a horizontal line centered in work table 32 and perpendicular to front panel 75, perpendicular to one another, with transition panels 29, 28 of mechanisms 20 spaced closely next to one another. Thus arranged, pairs of mechanisms 30 may optionally be employed in tandem, in a manner similar to that described in co-pending application Ser. No. 09/687,358, filed Oct. 13, 2000, the entire disclosure of which is hereby incorporated by reference into this present application.

As shown in FIGS. 1 and 18, left and right guide plates 36L and 36R have inner longitudinally disposed vertical wall surfaces 238L and 238R, respectively. If extended inwardly or rearwardly towards the center of work table 32, inner vertical surfaces 238L and 238R of guide plates 36L and 36R would intersect to form a right angle corner. However, as shown in FIGS. 1, 2, and 18, inner ends of guide plates 36L and 36R are truncated by an obliquely disposed cutting plane which forms obliquely disposed inner vertical transverse face walls 239L and 239R, respectively, that are coplanar with the cutting plane, and angled at 45 degrees to inner vertical side walls 238L and 238R. Thus arranged, inner vertical side walls 238L and 238R form guide surfaces along which may be slid the outer side walls of side channel members or moldings of a rectangular picture frame that intersect each other at a ninety-degree corner. A laterally disposed space 240 between opposed inner corners 241L and 241R of guide plates 36L and 36R allows the corner of a picture frame to protrude inwardly beyond inner face walls 239L and 239R of the guide plates.

As may be seen best by referring to FIGS. 1, 8, 10, and 18, clamping jig 33 includes a horizontally disposed, elongated straight clamp bar 38 located below and in vertical alignment with clamp beam member 35. Clamp bar 38 is vertically movably held with respect to clamp beam member 35. Thus, as shown in FIGS. 1, 8, and 18, clamping jig 33 includes a linear actuator comprising a double acting pneumatic cylinder 40, for raising and lowering clamp bar 38. Clamp bar cylinder 40 is mounted on the upper surface 41 of clamping jig support beam 35, and has a piston rod 42 which protrudes vertically downwards through a bore 43 provided through the thickness dimension of the support beam. The lower end of piston rod 42 has a square transverse sectional shape which protrudes through a similarly shaped bore through clamp bar 38, and is secured to the clamp bar by a screw 39. Since pneumatic cylinder 40 is of the type in which piston rod 42 is non-rotatable, clamp bar 38 is maintained in a fixed horizontal orientation when moved vertically with respect to work table 32.

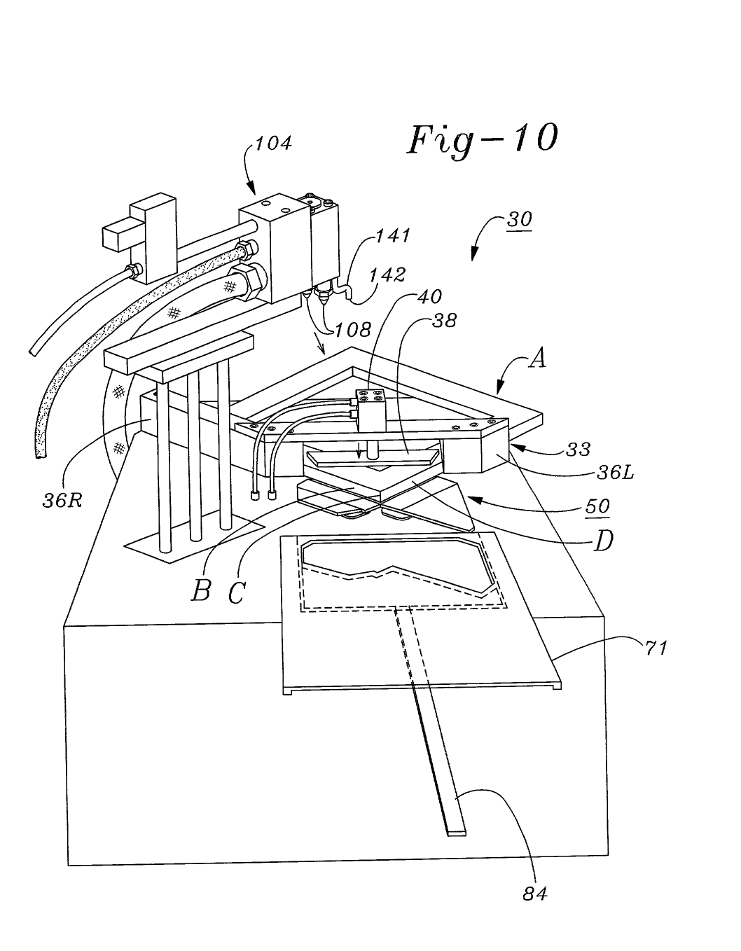

As shown in FIGS. 2 and 18, clamp bar cylinder 40 has an upper pressurized “down” air inlet port 44 connected to a first “down” air inlet hose 45, and a second, lower, “up” air inlet port 46 connected to a second, “up” air inlet hose 47. Hoses 45 and 47 connect to tubular fittings 48 and 49 which protrude downwards through upper surface 34 of work table 32, to control valves and a source of pressurized air, as will be discussed in detail below. When pressurized air is supplied to “up” inlet port 46 of clamp air cylinder 40, pressurized air on the lower side of a piston within the cylinder forces the piston, attached piston rod 42, and attached clamp bar 38 upwards to an upper, unlocked position, as shown in FIG. 1. Conversely, when pressurized air is supplied to “down” inlet port 44 of clamp air cylinder 40, pressurized air on the upper side of the piston within the cylinder forces the piston and clamp bar 38 downwards to a lower position in clamping contact with a picture frame A, as shown in FIG. 10.

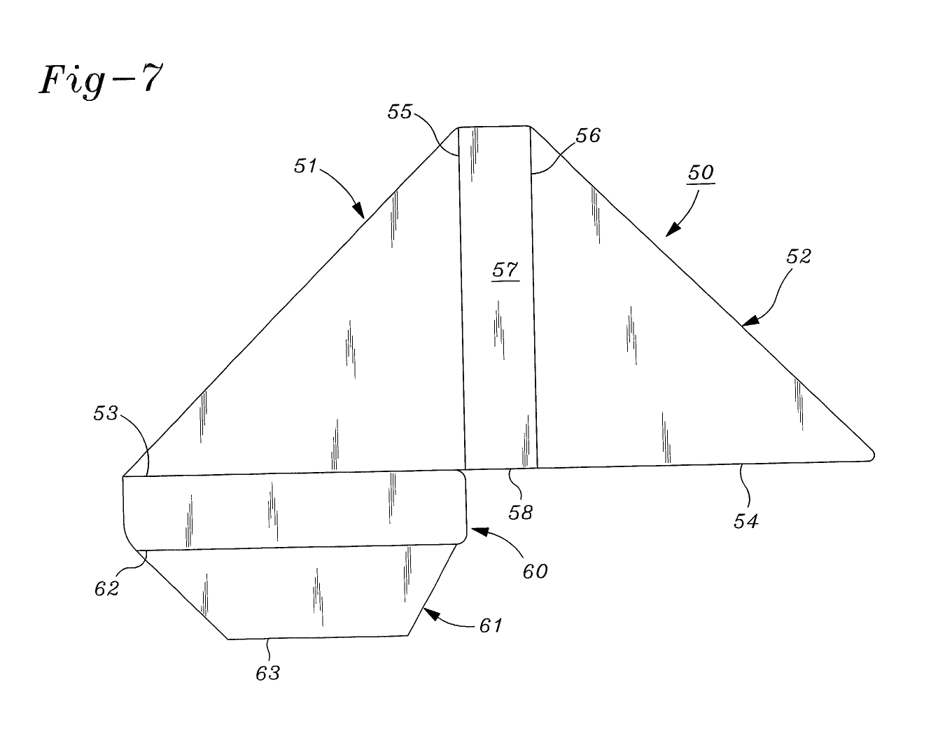

A preferred embodiment of mechanism 30 according to the present invention includes a feeder mechanism 70 for automatically feeding a single corner protector preform 50 at a time to a pre-determined position beneath clamping bar 38 of clamping jig 33, prior to inserting a frame to be protected into the clamping jig. The structure and function of feeder mechanism 70 may be best understood by first reviewing the construction of corner protector preforms 50 used with apparatus 30. FIG. 7, shows a corner protector preform 50 of the type the apparatus 30 is intended to be used with.

As shown in FIG. 7, preform 50 is made of a thin sheet of readily bendable material, such as corrugated cardboard. Preform 50 has two laterally mirror symmetric, left and right right triangularly-shaped panel sections bendable out the plane of the sheet to form lower and upper triangular cover flaps 51 and 52, respectively. In the orientation of preform 50 shown in FIG. 7, flap 51 is on the left-hand side of the figure, and will be referred to as the left-hand flap as a matter of convenience throughout the ensuing discussion. Left and right, lower and upper triangular coverflaps 51 and 52 have collinear horizontal bases 53 and 54 joined at their respective ninety degree corner angles to opposite vertical sides 55 and 56 of a vertically elongated, rectangular panel section comprising an inner spine flap 57, which has a base 58 collinear with the bases of the triangles. Thus shaped, preform 50 has an appearance approximating that of an isosceles triangle having a horizontal base 53-58-54 and an upper vertex truncated by a horizontal edge 59 parallel to the base.

Referring still to FIG. 7, preform 50 may be seen to include a horizontally elongated, rectangularly shaped panel section comprising an outer spine flap 60 which depends downwardly from base 53 of left-hand triangular flap 51, and has the same width as that flap. A trapezoidally-shaped securement flap 61 depends downwardly from the bottom edge wall 62 of outer rectangular spine flap 60, the securement flap having an upper edge wall coextensive with bottom edge wall 62 of the outer spine flap, and a lower edge wall 63 parallel to but shorter than edge wall 62.

In a preferred embodiment of corner protector preform 50, the width of inner, vertical spine flap 57 and the height of outer, horizontal spine flap 60 are each equal to a common value which is slightly greater than the thickness of a typical picture frame, e.g., about 15/16 inch, for a frame thickness of ⅞ inch. As shown in FIG. 7, preform 50 is preferably scored along edge walls 55 and 56 of inner, vertical spine flap 57, and along edge walls 53 and 62 of outer, horizontal spine flap 60. These score lines are located along boundaries between adjacent flaps, and facilitate folding the flaps out from the plane of a preform and around a picture frame corner, as will be explained below.

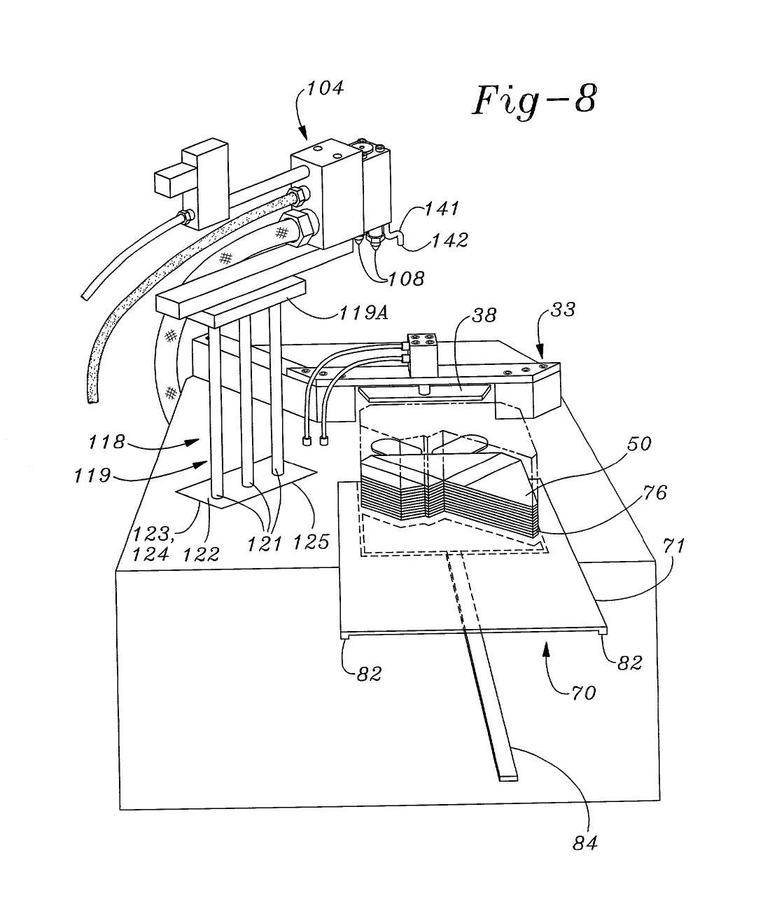

Referring again to FIGS. 2 and 8, corner protector feeder mechanism 70 may be seen to include a longitudinally elongated, rectangularly shaped guide plate 71 having a generally flat upper surface mounted above and parallel to upper surface 34 of work table 32. Guide plate 71 is oriented with its long axis parallel to left and right side walls 72 and 73 of enclosure 31, and protrudes rearwardly beyond rear side wall 74 of the enclosure. As shown in FIGS. 1, 2, and 8, guide plate 71 of feeder mechanism 70 has through its thickness dimension a perforation 76 having substantially the same outline shape as corner protector preform 50. Guide plate 71 is spaced above upper surface 34 of table 32 by longitudinally disposed support ribs 82, at a distance slightly greater than the thickness of corner protector preform 50, e.g., 5/16 inch for preforms having a thickness of about ¼ inch. Thus, a corner protector preform 50 placed conformally over perforation 76 will drop through the aperture onto work table surface 32, allowing the preform to be slid into operating position under clamping jig 33, as will be described in detail below.

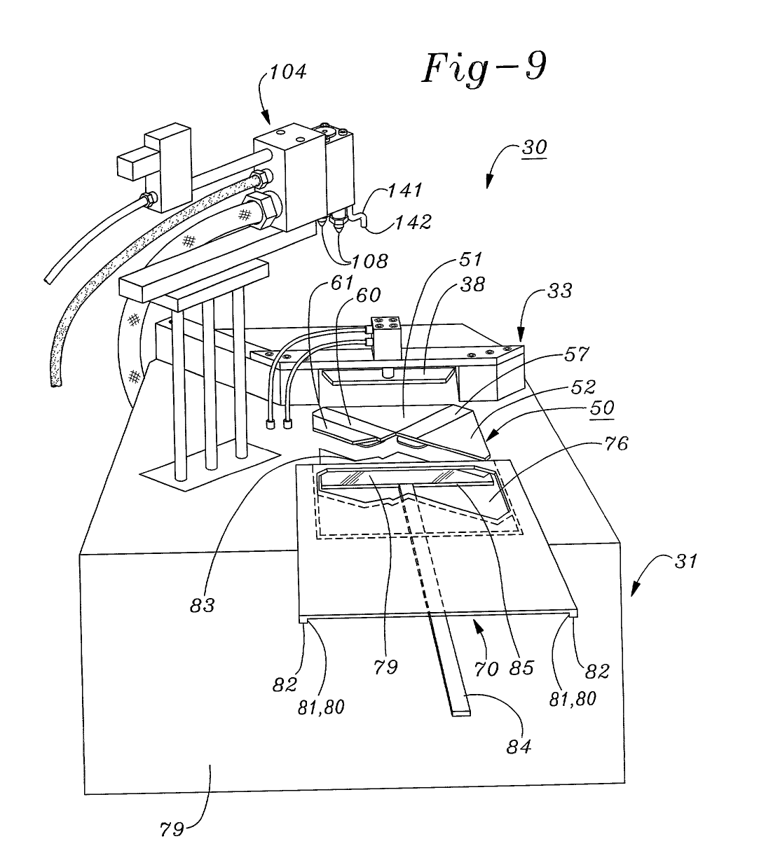

As may be seen best by referring to FIG. 9, feeder mechanism 70 includes a pusher plate 79 longitudinally slidably mounted in longitudinally disposed guideways consisting 11 of grooves 80 provided in inner facing walls 81 of guide plate support ribs 82. Pusher plage 79 has a generally uniform thickness, and has a front edge wall 83 in which is formed a groove shaped complementarily to the lower edge wall of preform 50. Preferably, pusher plate 79 is made of DELRIN, NYLON, or a similar structural polymer that has good lubricity.

As shown in FIG. 9, pusher plate 79 has protruding perpendicularly from a rear edge 85 thereof an elongated straight push rod member 84 which protrudes rearwardly of rear vertical wall panel 74 of enclosure 31. Push rod 84 is reciprocally and cyclically actuated longitudinally, i.e., perpendicularly to rear edge 85 of pusher plate 79, in a forward direction to feed a preform 50 forward under clamping jig 33, and rearwardly to retract front edge 83 of the pusher plate into alignment with the rear edge wall of aperture 76 through guide plate 71, to thereby enable a next preform 50 in a stack to drop through the aperture preparatory to its being fed forward for installation on another picture frame corner. In a preferred embodiment, push rod 84 is coupled to the piston of a double acting pneumatic cylinder (not shown) used to cyclically advance and retract pusher plate 79.

In a preferred embodiment of apparatus 20, as shown in FIG. 1, corner protector installation mechanism 30 includes a plurality of vertically disposed guide rods 77 which protrude perpendicularly upwards from upper surface 34 of work table 32. Guide rods 77 define between tangents to the outer wall surfaces of inner facing sides of the rods a uniform transverse cross-section, vertically disposed bore 78 which is vertically aligned with guide plate perforation 76 and which is adapted to receive a vertical stack of preforms 50.

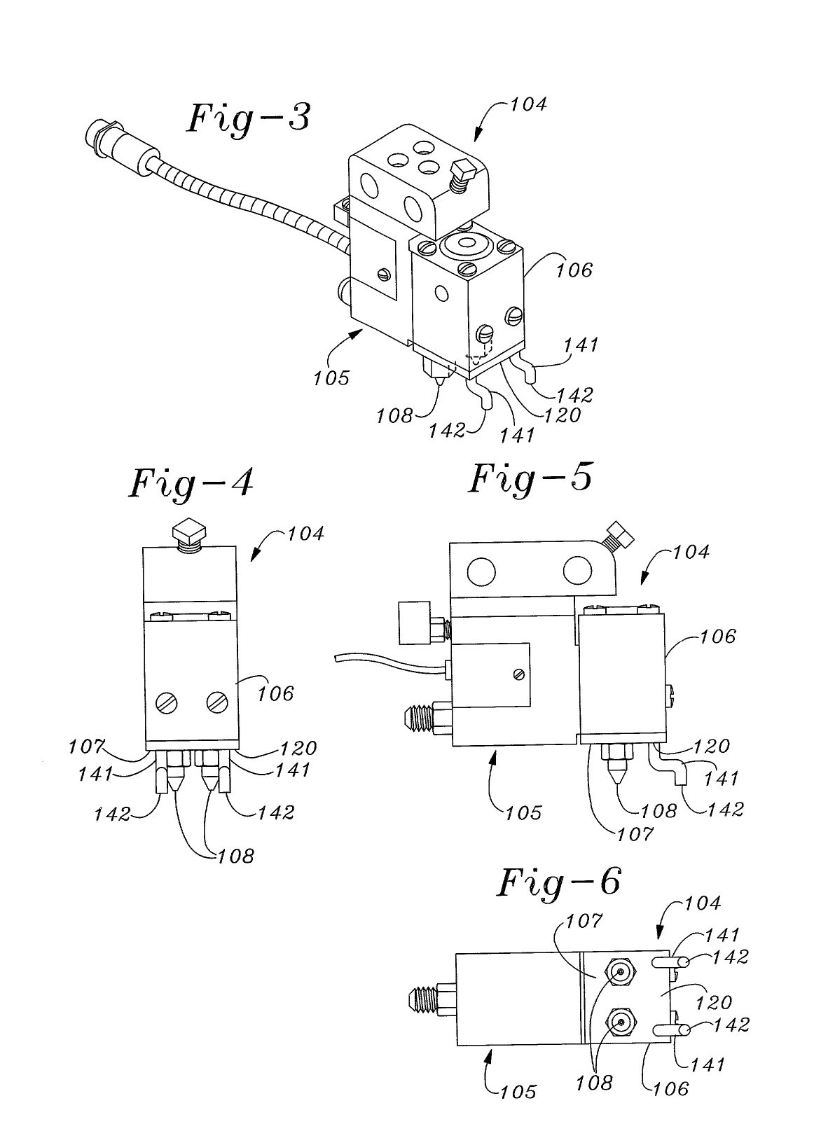

Referring now to FIGS. 1, 2 and 8, it may be seen that corner protector installation mechanism 30 includes an adhesive dispensing apparatus 101 for dispersing quantities of adhesive used for bonding corner protectors 50 to picture frames. In a preferred embodiment, adhesive dispensing apparatus 101 includes a hot melt adhesive machine, such as the Autotech Model AT15 Hotmelt Unit, manufactured by the Slautterback Corporation, located at 5 Lower Ragsdale Drive, Monterey, Calif. 93940-5779. As shown in FIG. 2, this embodiment of an adhesive dispensing apparatus includes a machine 102 for melting solid polymer sticks and pumping the molten polymer, and a thermally blanketed, high pressure hose 103 for conveying hot, molten polymer adhesive to an applicator head 104. As shown in FIGS. 3-6, applicator head 104 has a horizontally elongated body 105 including a generally rectangular block-shaped front portion 106 having a flat, horizontally disposed lower surface 107 from which protrude one or preferably two adhesive dispensing nozzles 108. Hot melt adhesive dispensing apparatus 101 includes a pressurized air hose 109 and electrical control cable 110 which are interconnected between hot melt pumping machine 102 and applicator head 104. Machine 102 includes a melting tank (not shown) located below a hinged lid 111 for receiving and melting sticks of hot melt polymer adhesive, such as H. B. Fuller type HL 9254 hot melt adhesive received into the tank. This type adhesive has a working temperature range of about 270° F. to 325° F. Machine 102 includes an internal heater, and internal control mechanisms which, in response to electrical command signals supplied from an external source, pump molten hot melt adhesive from the melting tank through delivery hose 103 to applicator head 104. Internal control mechanisms within machine 102 also provide electric signals through control cable 110 to applicator head which control pressurized air supplied to the had through hose 109.which operate valves within the head, causing jets of pressurized liquid hot melt adhesive to be sprayed from nozzles 108 upon receipt of an external command signal.

As may be seen best by referring to FIGS. 2, 8, and 18, corner protector installation apparatus 20 includes an adjustable support structure 118 for holding and supporting at an adjustable longitudinal distance, or throat depth, applicator head 104 of the apparatus relative to a picture frame held in clamp jig 33.

Support structure 118 is mounted on the upper end of a compressor/elevator actuator mechanism 119 which lowers applicator head 104 to force a pair of fingers 141 having flat, co-planar horizontally disposed anvil surfaces 142 which protrude downwards from a front flat anvil portion 120 of head 104 into compressive contact with a corner protector 50 on a picture frame to press flaps of the corner protector preform into bonding contact with semi-liquid hot melt adhesive, upon completion of the adhesive application operation, as will be explained in detail below.

As may be seen best by referring to FIGS. 2, 8, and 18, compressor/elevator actuator 119 of hot melt adhesive dispensing apparatus 101 includes a row of three vertically disposed, laterally spaced apart and aligned support rods 121 fastened at the upper ends thereof to the lower portion of spray gun applicator head support structure 119A. Support rods 121 are vertically slidably supported in sleeve bearings 122 located below an elongated rectangular base plate 123. Base plate 123 is fastened to a structural member 124 within enclosure 31, and is located below a similarly-shaped aperture 125 through work table 32.

Referring now to FIGS. 2 and 8-1 0, corner protector installation mechanism 30 may be seen to include a pair of corner flap folder actuators 130L and 130R located on the left and right sides, respectively, of a longitudinal center line of work table 32 of the apparatus. As shown in FIG. 2, flap folder actuators 130L and 130R are located longitudinally inwards of clamping jig 33, in a location that places the actuators adjacent to the sides of a frame inserted inwardly under clamp bar 38 of clamping jig 33. Flap folder actuators 130L and 130R are identical in structure and function. Therefore, in the ensuing description, the flap folder actuators will be referred to generally without a subscript.

As shown in FIGS. 2 and 8, each flap folder actuator 130, such as left-hand folder actuator 130L, may be seen to include a flat, rectangularly-shaped flap folder arm 131 which fits into a complementarily shaped recess 129 provided in upper surface 34 of work table 32, flush with the upper surface. Arm 131 is oriented with a long, inner longitudinal edge 132 thereof parallel and adjacent to a side of a picture frame protruding diagonally inwardly from beneath clamp bar 38 of clamping jig 33.

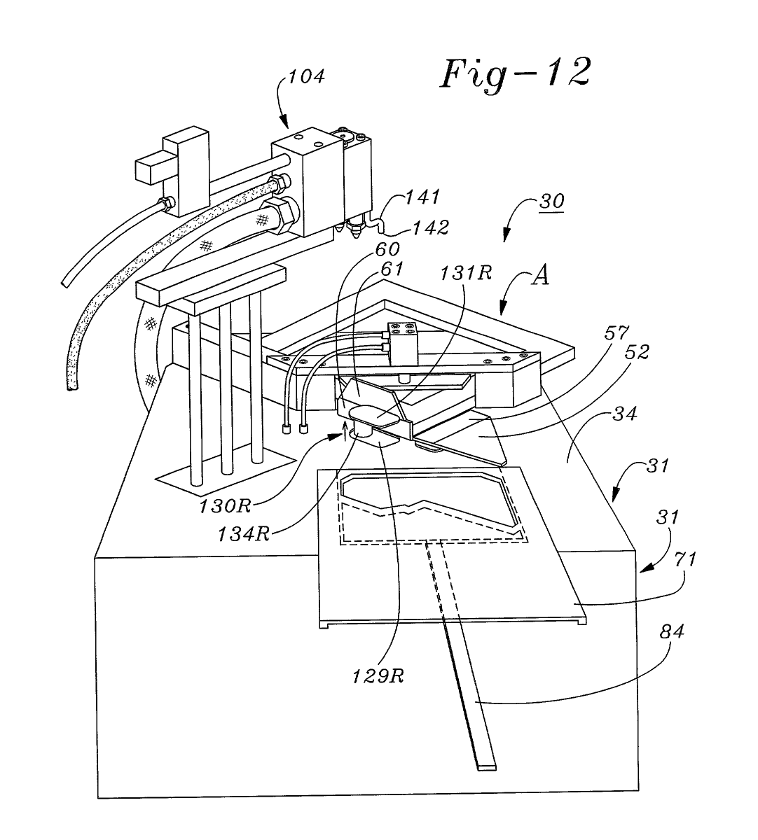

As may be seen best by referring to FIG. 12, each flap holder arm 131 is mounted on the upper transversely disposed horizontal end wall 133 of a vertically disposed, cylindrically-shaped support post 134. Also, corner protector installation mechanism 30 includes a linear actuator for elevating support post 134 along its longitudinal axis, to thereby elevate flap folder arm 131 attached to the upper end of the support post upwardly from its rest position recessed in upper surface 34 of work table 31, and a rotary actuator for reciprocally rotating elevator support post 134 about its longitudinal axis, to thereby rotate the flap folder arm ninety degrees away from and back to its rest position, where the linear actuator retracts the flap folder arm into recess 129.

Corner protector installation mechanism 30 according to the present invention also includes preferably sensor means which provides a signal indicating that a corner of a picture frame has been fully inserted into clamping jig 33, with the frame moldings adjacent the corner parallel to and proximate inner vertical wall surfaces 238R, 238L of guide plates 36R, 36L.

Various types of proximity or optical sensors suitable for the foregoing purpose are well known to those skilled in the art. In an example embodiment of apparatus 20 tested by the present inventor, each sensor 170 consisted of a UZJ-111, fixed-focus type micro-photo sensor, manufactured by Matsushita Electric Works, Ltd., Automation Controls Group, 1048 Kadoma, Osaka 571, Japan. That sensor contains an infrared light emitting diode and phototransistor arranged within a circuit module with their optical axes generally parallel, and their respective exit and entrance pupils adjacent each other behind an infrared window comprising the outer face of the module. When a surface such as the outer surface of a picture frame molding is positioned within about 5 mm±2.5 mm of the outer face of the sensor, an output transistor within the sensor is turned on, providing a logic TRUE current through a load resistor connected in series with a collector supply voltage, and the emitter and collector output terminals of the sensor.

As shown in FIG. 1, a pair of sensors 170R, 170L of the type described above with their outer faces installed in guide plates 36R, 36L, flush with inner surfaces 238R, 238L of guide plates 36R, 36L, respectively, near the inner transverse vertical end walls 171R, 171L thereof, and near upper surface 34 of work table 32. Each sensor 170 produces a logic TRUE signal when a frame molding is parallel to and a predetermined distance from inner surface 238R, 238L adjacent the outer face of the sensor. Moreover, apparatus 20 includes an electronic AND circuit 172 for logically ANDING signals from the output terminals of two sensors 170R, 170L of corner protector installation mechanism 30. The output signal from the AND circuit is false when either of the 2 sensors 170R, 170L outputs a false signal, indicating that a picture frame molding near that sensor is not substantially close to and parallel to the sensor. However, when the corner of a frame has been fully inserted into and properly aligned with clamping jig 33 of corner protector installation mechanism 30 of apparatus 20. The logical AND circuit produces a TRUE output signal which initiates a sequence of automatic operations of the corner protector installation mechanism, which are described below. Electronic circuitry for performing the foregoing functions is well known to those skilled in the art, and therefore need not be described in further detail here. For example, such circuitry can be implemented in a Programmable Logic Controller, PLC 133, or a general purpose microprocessor or micro controller.

Operation of the Invention

In response to a TRUE output signal from AND circuit 172 when both sensors 170L, 170R produce TRUE output signals, Programmable Logic Controller (PLC) 133 issues in sequence drive signals to the various actuators of corner protector installer mechanism 30 of apparatus 20 according to the present invention, as follows:

1. Vertical stacks of corner protector preforms 50 are loaded into bores 78 between guide rods 77 of feeder mechanisms 70 of installer mechanism 30. (FIGS. 1 and 8)

2. Power is turned on and PLC 133 resets and checks mechanism 30 of apparatus 20, readying the PLC for outputting sequential drive signal commands to the various actuators of the apparatus. A program for the operational sequence of apparatus 20 is stored in electronic memory means in PLC 133. This program can be executed via an internal or external computer. (FIG. 2)

3. Actuator cylinder 92 of feeder mechanism 70 in installer mechanism 30 is actuated to reciprocate piston rod 94, thereby moving an individual corrugated corner protector blank preform 50 forward into position below clamp bar 38 of the installer mechanism. (FIG. 9)

4. A first corner C1 of a picture frame A having left and right channel moldings D and B is inserted into position beneath clamp bars 38 and over blank 50 of installer mechanism 30. (FIG. 10)

5. Frame A is positioned relative to apparatus 20 so that corner C1 of the frame is fully inserted into clamping jig 33 of mechanism 30. (FIG. 10)

6. Sensors 170L, 170R of installer mechanism 30 output TRUE signals, causing AND circuit 172 to output a TRUE signal, in turn causing PLC 123 to simultaneously issue drive signals to the installer mechanism, as follows: (FIG. 10)

7. Hold down clamp bar 38 of clamping jig 33 of mechanism 30 is forced downward onto the adjacent molding channels D and B of frame A which intersect at corner C1. (FIG. 10)

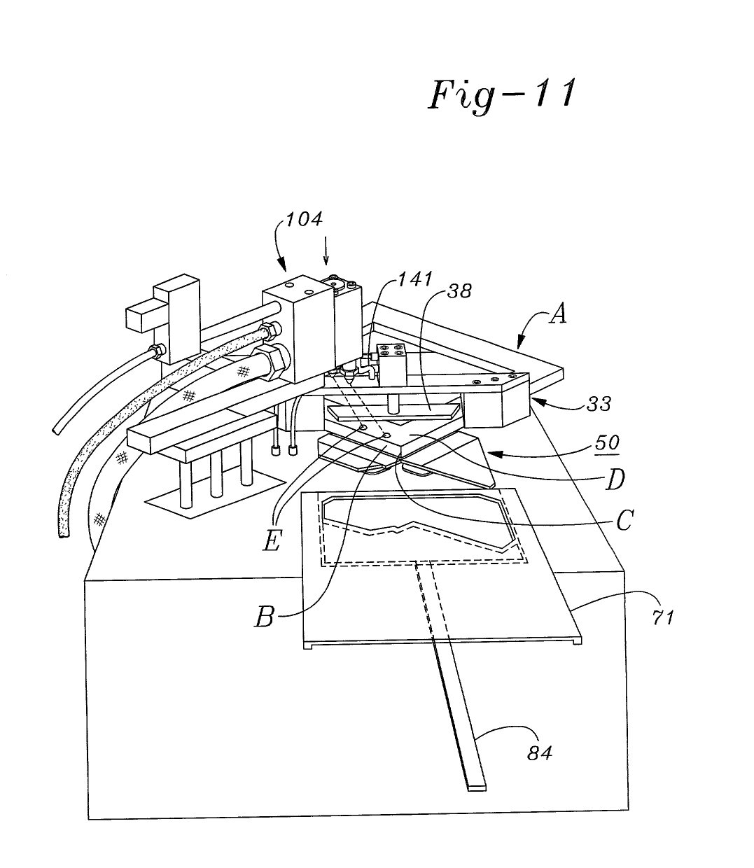

8. Hot melt adhesive machine 102 is then actuated, causing applicator head 104 to spray blobs E of semi-liquid hot melt adhesive onto the upper surface of left-hand frame molding D. (FIG. 11)

9. Blank preform 50 under corner C1 of frame A is automatically manipulated as follows: First, rectangular outer spine flap 60 and securement flap 61 of preform 50 are bent upwardly in unison into a vertically disposed orientation by elevating right-hand flap folder arm 131R of mechanism 30 from its recess 129R, with the flap folder arm in its clockwise position. (FIG. 12)

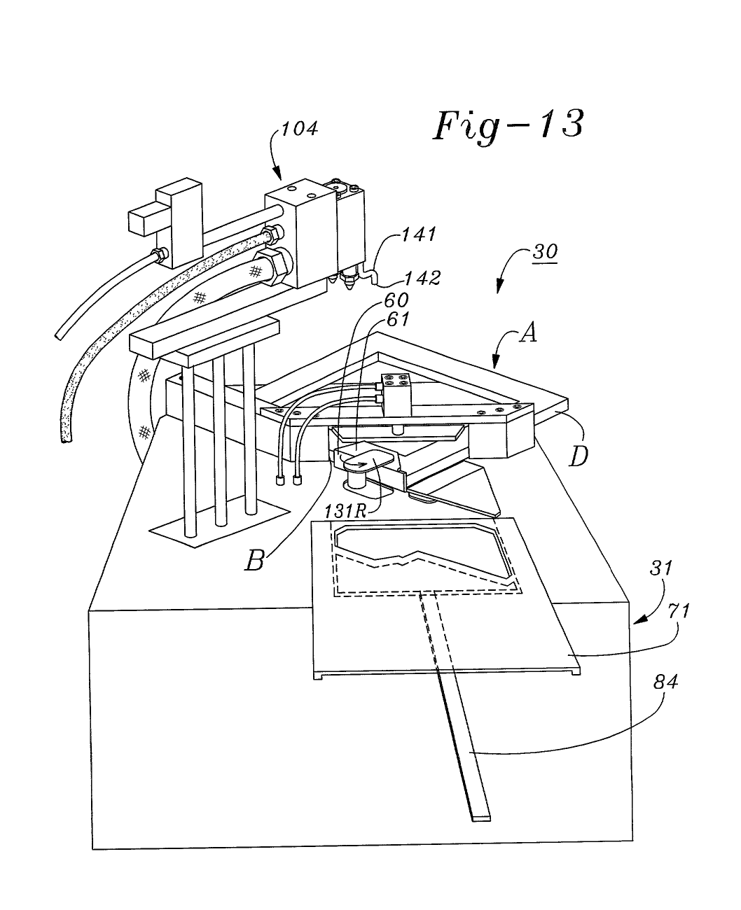

10. Securement flap 61 of preform 50 is bent inwardly and downwardly over left frame channel D by rotating right-hand flap folder arm 131R counterclockwise. (FIG. 13)

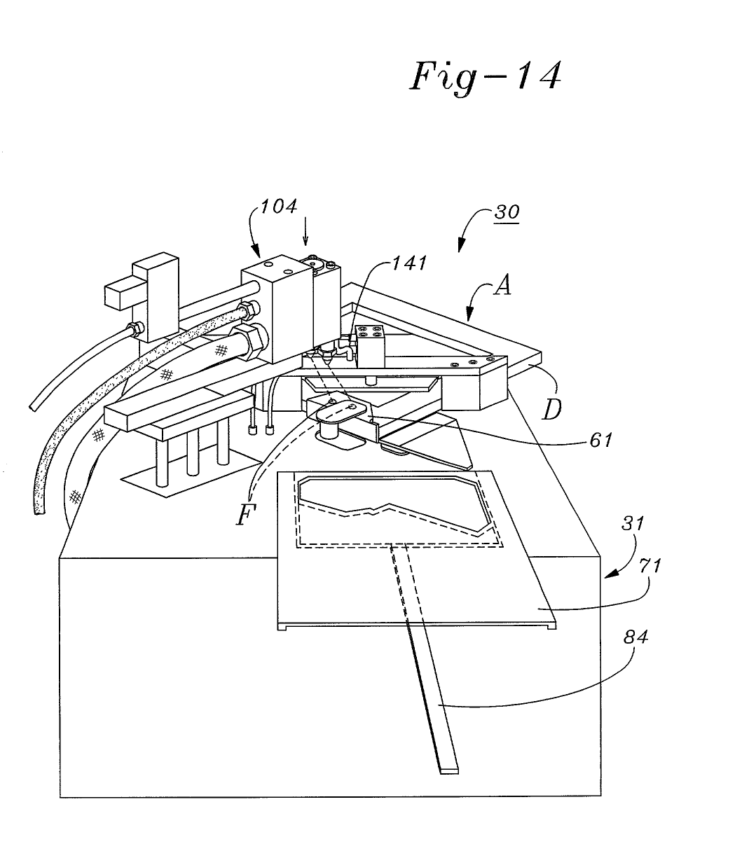

11. Hot melt adhesive applicator head 104 is again actuated to spray blobs F of semi-liquid adhesive onto the upper surface of securement flap 61. (FIG. 14)

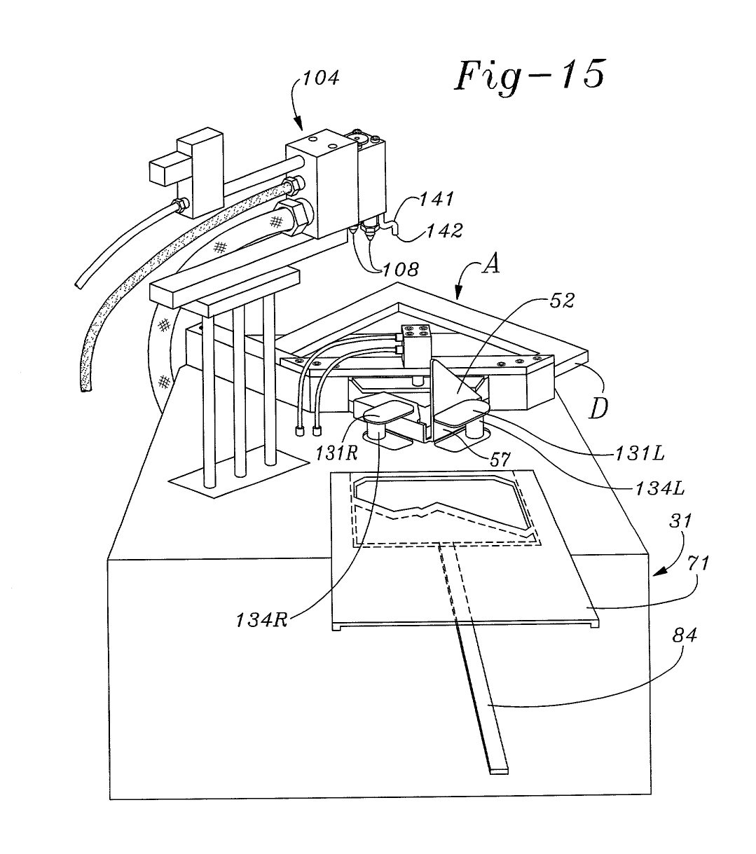

12. Right-hand, upper triangular cover flap 52 and inner spine flap 57 of preform 50 are bent as a unit into a vertically disposed orientation by extending right-hand flap folder arm 162R upwardly from recess 129R. (FIG. 15)

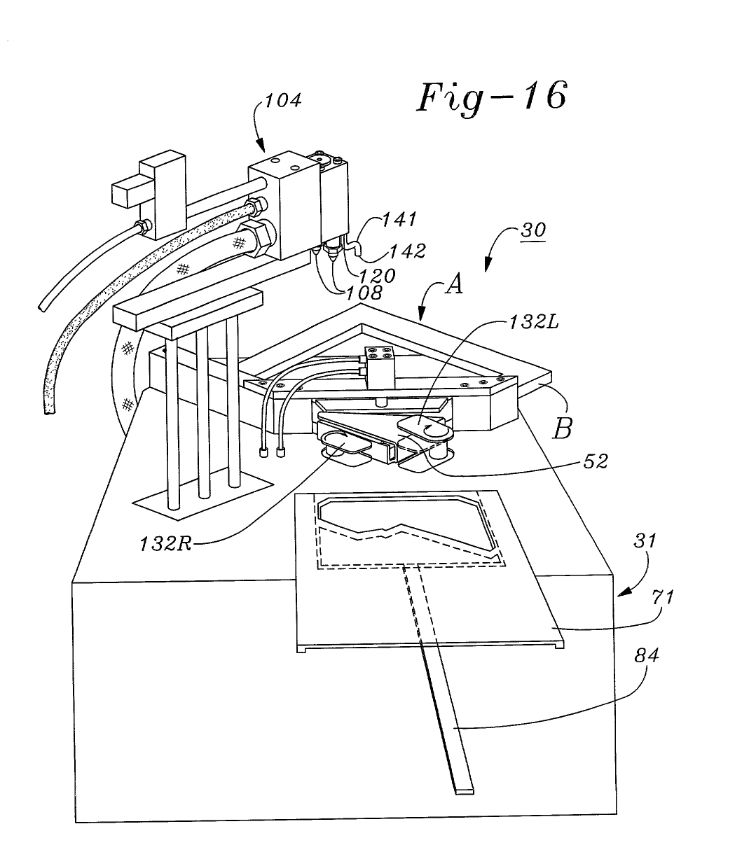

13. Upper cover flap 52 of preform 50 is bent inwardly and downwardly over right-hand frame channel B by rotating flap folder arm 152L ninety degrees clockwise. (FIG. 16)

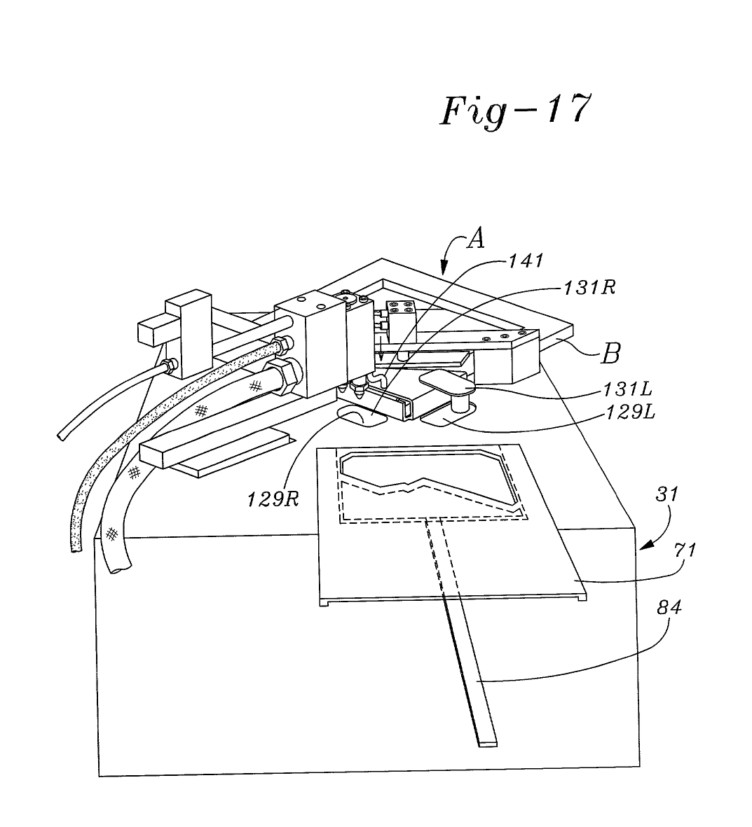

14. Right flap folder arm 131R is rotated ninety degrees clockwise to its angular rest position, and retracted downwardly into recess 129R to its vertical rest position. (FIG. 17)

15. Hot melt adhesive applicator head gun 104 of mechanism 30 is lowered toward frame A, pressing fingers 141 protruding downwardly from front flat anvil portion 120 of the head, located forward of nozzles 108, down against upper flap 52, thereby pressing the flap down into blobs of adhesive between it and securement flap 61. (FIGS. 17, 18, 19)

16. Left flap folder arm 131L of mechanism 30 is rotated ninety degrees counterclockwise to its angular rest position. (FIG. 2)

17. Left flap folder arm 131 L of mechanism 30 is retracted downwardly into recess 129L to its vertical rest position. (FIG. 2)

18. Hold down clamp bar 38 of clamping jig 33 of mechanism 30 is retracted vertically upwards to its rest position, unclamping corner C1 of frame A. (FIG. 9)

19. Frame A is retracted from apparatus 20, disengaging corner C1 from clamping jig 33.

20. Frame A is rotated ninety degrees in a horizontal plane, and steps 4-18 repeated to attach a corner protector 50 to a second corner C2 of frame A.

21. Step 20 is repeated for the remaining two corners C3, C4 of frame A.

What is claimed is:

1. A method for attaching a protective cover to a corner of a frame, said corner being defined by the intersection at a dihedral angle of two adjacent elongated intersecting channel members comprising two adjacent sides of said frame, said method comprising;
a. placing said frame corner over a corner protector preform comprising a thin sheet of flexible material, said sheet being foldable into a plurality of flaps,
b. depositing a first quantity of adhesive on a surface of a first said frame channel member,
c. bending upwardly from the plane of a base portion of said preform located beneath said frame a first flap section,
d. bending downwardly and inwardly toward said first channel member from the plane of said first flap section a portion thereof to thereby overlie said first quantity of adhesive on said first frame channel member,
e. depositing a second quantity of adhesive on an upper surface of said portion of said first flap section overlying said first quantity of adhesive,
f. bending upwardly from the plane of said base portion of said preform a second flap section,
g. bending downwardly and inwardly toward said second frame channel member a portion of said second flap section to thereby overlie said second quantity of adhesive,
h. pressing said overlying portion of said first flap section downwardly against said first quantity of adhesive to thereby adhere said overlying portion of said first flap section to said first frame channel member, and
i. pressing said overlying portion of said second flap section downwardly against said second quantity of adhesive to thereby adhere said overlying portion of said second flap portion to said first flap portion.

2. The method of claim 1 wherein said first flap section includes a laterally elongated generally rectangularly-shaped outer spine flap having a height approximating that of said first frame channel member and adapted to lie vertically adjacent thereto, and a securement flap adapted to be bent perpendicularly inwardly over an upper surface of said first frame channel member along a laterally disposed fold line joining said securement flap to said outer spine flap.

3. The method of claim 2 wherein said second flap section includes a vertically elongated, generally rectangularly-shaped inner spine flap having a width approximating the height of said second channel member and adapted to lie vertically adjacent thereto, and an upper cover flap adapted to be bent perpendicularly inwardly over an upper surface of said second frame channel member along a vertically disposed fold line joining said upper cover flap to said inner spine flap, said upper cover flap having an inwardly protruding portion which overlies at least a portion of said securement flap.

4. The method of claim 3 wherein said base portion of said preform is further defined as forming a lower cover panel for said frame when said preform is secured to said frame.

5. The method of claim 4 wherein said base portion of said preform is further defined as having in plan view a right triangular shape, the base of which is in parallel vertical alignment with said first frame channel member, and the altitude of which is in parallel vertical alignment with said second frame channel member.

6. The method of claim 5 wherein said upper coverflap is further defined as having in plan view a right triangular shape, the base of which is in parallel alignment with said first channel member and the altitude of which is in parallel alignment with said second channel member.

7. The method of claim 4 wherein said base portion of said preform is further defined as having in plan view a rectangular shape, a first, base side which is in parallel vertical alignment with said first frame channel member, and a second side intersecting said first side which is in parallel vertical alignment with said second frame channel member.

8. The method of claim 7 wherein said upper cover flap is further defined as having in plan view a rectangular shape, a first, base side of which is in parallel vertical alignment with said first channel member and a second side intersecting said first side which is in parallel vertical alignment with said second frame channel member.

9. The method of claim 1 wherein said depositing of at least one of said first and second quantities of said adhesive comprises spraying said adhesive.

10. The method of claim 9 wherein said adhesive is a molten hot-melt adhesive.

11. A method for attaching a protective cover to a corner of a frame such as a picture frame, said corner being defined by the intersection at a dihedral angle of two adjacent elongated intersecting channel members comprising two adjacent sides of said frame, said method comprising;
a. placing said frame corner over a flat corner protector pre-form comprising a thin sheet of flexible material, said sheet having
(i) a vertically elongated rectangular inner spine flap having a width approximately equal to the thickness of said intersecting channel members,
(ii) a first, lower cover flap having a vertical side coextensive with a first vertical side of said inner spine flap, and a base collinear and coextensive with a lower horizontal base of said inner spine flap,
(iii) a horizontally elongated, rectangularly-shaped outer spine flap depending downwardly from said base of said first, lower cover flap, said outer spine flap having a height approximately equal to the thickness of said intersecting channel members of said frame,
(iv) a horizontally elongated securement flap depending downwardly from said outer spine flap,
(v) a second, upper, cover flap shaped similarly to said first, lower cover flap and joined to a second vertical side of said inner spine flap in a laterally opposed location to said first lower cover flap,
b. depositing a first quantity of adhesive on a surface of said first frame channel member,
c. folding upwards from the plane of said first, lower cover flap of said corner protector preform said outer spine cover flap and said securement flap adjacent a side wall of said first channel member,
d. folding said securement flap perpendicularly inwards from said inner cover flap to overlie said first quantity of adhesive on said first channel member,
e. depositing a second quantity of adhesive on an upper surface of said securement flap overlying said first quantity of adhesive,
f. folding upwards from the plane of said corner protector preform said inner spine flap and said second upper flap adjacent a side wall of said second channel member,
g. folding said second upper cover flap perpendicularly inwards along said junction line between said second vertical edge wall of said inner spine flap and said upper cover flap to overlie said second quantity of adhesive on said securement flap and the upper wall surface of said second channel member,
h. pressing said securement flap downwardly against said first quantity of adhesive to thereby adhere said securement flap to said first frame channel member, and
i. pressing said upper cover flap downwardly against said second quantity of adhesive to thereby adhere said upper cover flap to said securement flap.

12. The method of claim 11 wherein the upper surface of said corner protector preform which is located at said first vertical side of said inner spine flap coextensive with said side of said lower cover flap is further defined as being scored to facilitate folding of said inner spine flap relative to said lower cover flap.

13. The method of claim 12 wherein the upper surface of said corner protector preform on which is located said second vertical side of said inner spine flap is further defined as being scored to facilitate folding of said upper cover flap relative to said inner spine flap.

14. The method of claim 13 wherein the upper surface of said corner protector preform on which is located the intersection between said lower cover flap and said outer spine flap further defined as being scored to facilitate folding of said outer spine flap relative to said lower cover flap.

15. The method of claim 14 wherein the upper surface of said corner protector preform on which is located the intersection between said securement flap and said outer spine flap is further defined as being scored to facilitate folding of said securement flap relative to said outer spine flap.

16. The method of claim 15 wherein said base portion of said preform is further defined as having in plan view a right triangular shape, the base of which is in parallel vertical alignment with said first frame channel member, and the altitude of which is in parallel vertical alignment with said second frame channel member.

17. The method of claim 16 wherein said upper cover flap is further defined as having in plan view a right triangular shape, the base of which is in parallel alignment with said first channel member and the altitude of which is in parallel alignment with said second channel member.

18. An apparatus for attaching a protective cover to a corner of a frame such as a picture frame, said frame having a pair of adjacent elongated frame channel members which intersect to form said corner, said protective cover being fabricated from a preform made of a thin sheet of flexible material, said apparatus comprising;
a. means for depositing a first quantity of adhesive on a surface of said first frame channel,
b. means for bending upwardly from the plane of a base portion of said preform comprising a lower cover flap and located beneath said frame a first flap section adjacent to a side of said first frame channel member,
c. means for bending downwardly and inwardly towards said first frame channel member from the plane of said first flap section an end portion comprising a securement flap thereof to thereby overlie said first quantity of adhesive on said first frame channel member,
d. means for depositing a second quantity of adhesive onto an upper surface of said securement flap overlying said first quantity of adhesive,
e. means for bending upwardly from the plane of said base portion of said preform a second flap section adjacent a side of said second frame channel member.
f. means for bending downwardly and inwardly towards said second frame channel member an end portion of said second flap section comprising a second, upper cover flap to thereby overlie said second quantity of adhesive,
g. means for pressing said securement flap downwardly against said first quantity of adhesive to thereby adhere said securement flap to said first frame channel member, and
h. means for pressing said second, upper cover flap against said second quantity of adhesive to thereby adhere said upper cover flap to said securement flap.

19. The apparatus of claim 18 wherein said means for bending adjacent a side wall of a first one of said pair of adjacent channel members a first flap section of said preform is further defined as being a first flap folder arm attached to a first end of a first vertically upwardly movable linear actuator, said arm being located in a first recess in the upper surface of a worktable, below said preform, whereby upward extensional motion of said first linear actuator forces said first flap section of said preform to bend upwardly from said worktable surface.

20. The apparatus of claim 19 wherein said means for bending perpendicularly inwardly from said first side flap section of said preform a securement flap overlying said frame channel member is further defined as being first rotary actuator means coupled to said first flap folder arm, said first rotary actuator means being effective in rotating said first flap folder arm from an elevated position vertically aligned with said first arm recess to a position overlying said first channel member, thereby bending over from said first flap section of said securement flap.

21. The apparatus of claim 20 wherein said means for bending adjacent a side wall of a second one of said pair of adjacent channel members a second flap section of said preform is further defined as being a second flap folder arm attached to a first, upper end of a second vertically upwardly movable linear actuator, said arm being located in a second recess in said upper surface of said worktable, below said preform, whereby upward extensional motion of said second linear actuator forces said second side portion of said preform to bend upwardly from said worktable surface.

22. The apparatus of claim 21 wherein said means for bending said second upper cover flap perpendicularly inwards from said section flap is further defined as being second rotary actuator means coupled to said second flap folder arm, said second rotary actuator means being effective in rotating said second flap folder arm from an elevated position vertically aligned with said second arm recess to a position overlying said second channel member.

23. The apparatus of claim 18 wherein said means for depositing adhesive onto said surface of said frame and said surface of said preform is further defined as including an applicator head having at least one nozzle adapted to spray liquid adhesive onto said surfaces.

24. An apparatus for adhesively bonding a corner protector preform to a corner of a frame such as a picture frame, said corner being defined by the intersection at a dihedral angle of first and second adjacent elongated intersecting channel members comprising two adjacent sides of said frame, said corner protector preform comprising a thin sheet of flexible material including
(i) a vertically elongated, rectangularly-shaped inner spine flap having a width approximately equal to the thickness of said intersecting channel members,
(ii) a first, lower face cover flap having a side coextensive with a first vertical side of said inner spine flap, and a base colinear with a laterally disposed base of said inner spine flap,
(iii) a horizontally elongated, rectangularly-shaped outer spine flap, which depends downwardly from said base of said first, lower face cover flap having a height approximately equal to the thickness of said intersecting channel members of said frame,
(iv) a horizontally elongated securement flap depending downwardly from said outer spine flap, and
(v) a second, upper face cover flap section shaped similarly to said lower face cover flap section and joined to a second vertical side of said inner spine flap in a laterally opposed location to said lower face cover flap, said apparatus comprising;
a. support means for supporting said preform and a corner of said frame overlying said lower cover flap of said preform,
b. means for depositing a first quantity of adhesive onto a surface of said first frame channel member,
c. means for bending upwardly and adjacent said first intersecting side channel member of said frame from the plane of said preform and said lower face cover flap, said outer spine flap and said securement flap,
d. means for bending inwardly from said outer spine flap said securement flap section to a location overlying said first side channel member of said frame,
e. means for depositing a second quantity of adhesive onto an upper surface of said securement flap overlying said first quantity of adhesive,
f. means for bending upwardly adjacent said second intersecting channel member of said frame from the plane of said preform and said lower face cover flap said inner spine flap and said upper face cover flap,
g. means for bending inwardly from said inner spine flap said upper face cover flap to position a portion thereof to a location overlying said quantity of adhesive on said securement flap,
h. means for pressing said securement flap downwardly against said first quantity of adhesive to thereby adhere said securement flap to said first frame channel member, and
i. means for pressing said second, upper cover flap against said second quantity of adhesive to thereby adhere said upper cover flap to said securement flap.

25. The apparatus of claim 24 further including means for releasably securing said frame to said supporting means of said apparatus.

26. The apparatus of claim 25 wherein said means for releasably securing said frame to said supporting means of said apparatus is further defined as being a clamping bar.

27. The apparatus of claim 26 wherein said clamping bar is further defined as being perpendicularly actuable relative to said support means.

28. The apparatus of claim 24 further including guide means for slidably receiving and holding in a fixed horizontal disposition relative to said support means.

29. The apparatus of claim 28 wherein said guide means is further defined as comprising in combination a pair of elongated blocks disposed obliquely to one another and having inner facing obliquely disposed wall surfaces inclined relative to one another at said dihedral angle of said frame, said blocks having between converging longitudinal ends thereof a laterally disposed space adapted to insertably receive said corner of said frame.

30. The apparatus of claim 24 wherein said support means is further defined as being a tabular body having a generally flat upper work surface.

31. The apparatus of claim 30 wherein said means for bending said outer spine flap and said securement flap from the plane of said lower face cover flap is further defined as comprising in combination a first flap folder arm having a flat wall surface disposed parallel to and spaced outwardly apart from said first frame channel member, and first linear actuator means for elevating said first flap folder arm vertically upwardly from a first recessed portion of said tabular body, flush with said upper work surface.

32. The apparatus of claim 31 wherein said means for bending said securement flap inwardly from said outer spine flap is further defined as first rotary actuator means coupled to said first linear actuator means, said first rotary actuator means being effective in rotating said inner wall of said first flap folder arm inwardly towards said first frame channel member.

33. The apparatus of claim 32 wherein said means for bending said inner spine flap and said upper face cover flap of said preform is further defined as comprising in combination a second flap folder arm having a flat inner wall surface disposed parallel to and spaced outwardly apart from said second frame channel member and second linear actuator means for elevating said second flap folder arm vertically upwardly from a second recessed portion of said tabular body, flush with said upper work surface.

34. The apparatus of claim 33 wherein said means for bending said upper face cover flap from said inner spine flap is further defined as second rotary actuator means coupled to said second linear actuator means, said second rotary actuator means being effective in rotating said inner wall of said second flap folder arm inwardly towards said second frame channel member.

35. The apparatus of claim 24 wherein said means for depositing adhesive onto said surface of said frame and said surface of said preform is further defined as including an applicator head having at least one nozzle adapted to spray liquid adhesive onto said surfaces.
